(19) United States
(12) Patent Application Publication
(10) Pub. No.: US 2008/0084596 A1
(43) Pub. Date: Apr. 10, 2008

(54) Active Mirror for Power Beaming

(75) Inventor: David Graham, Mountain View, CA (US)

Correspondence Address: FENWICK & WEST LLP, SILICON VALLEY CENTER, 801 CALIFORNIA STREET, MOUNTAIN VIEW, CA, 94041, US

(73) Assignee: PowerBeam, Inc., Sunnyvale, CA (US)

(21) Appl. No.: 11/868,316

(22) Filed: Oct. 5, 2007

Related U.S. Application Data
(60) Provisional application No. 60/828,581, filed on Oct. 6, 2006.

(51) Int. Cl. G02B 26/08; H04B 10/04; H04B 10/00; H04B 10/06

(52) U.S. Cl. 359/225; 398/201; 398/115; 398/212

(57) ABSTRACT

A mirror assembly with a reflecting surface is used to redirect a power beam through free space. The mirror assembly is actuated on at least one axis, and preferably at least two axes, so that it can move through many angles based on control signals from the power beaming system. The mirror assembly receives an optical transfer of power through free space from a power beam transmitter. Thus, the movement of the mirror is powered from the power beam itself. Two or more of these mirrors can be used in a power beaming system, thus creating many different beam paths through a volume of free space.

### RELATED APPLICATIONS

This application claims priority from U.S. provisional patent application Ser. No. 60/828,581 entitled “Mirror for Power Beaming,” filed Oct. 6, 2006. This application is related to U.S. patent application Ser. No. 11/370,523 filed Mar. 7, 2006 and PCT International Patent Application No. PCT/US/07/61007 filed Jan. 24, 2007, both entitled “Wireless Power Beaming to Common Electronic Devices.” The disclosures of all of the foregoing are incorporated herein by this reference.

### BACKGROUND OF THE INVENTION

1. Field of the Invention

This invention relates to free space optical transmission of power, and specifically to devices used to redirect beam paths.

2. Description of the Related Art

Fixed mirrors are commonly used to redirect light beams in optical systems. For example, fixed mirrors are sometimes used in systems at the doors to retail stores, where a light source points a beam of light across the doorway, and a mirror on the other side reflects the beam to a detector next to the emitter.

Active mirrors, i.e., mirrors that move using an electronic mechanism, are commonly used in solar concentrators, where the mirrors tilt to follow the sun, and solar energy is focused and redirected onto a solar cell. When this is done, the power for the logic and the motors to turn the reflector usually comes through a cord from an external electric power source, so that there is sufficient power to turn to follow the sun. This is necessary because when the array points away from the sun, it generates no power. In principle, one could power an active mirror for steering a laser beam from batteries or from electrical wires, but these are inconvenient in installation and application.

### SUMMARY

Aspects of the present invention include a mirror assembly with a reflecting surface used to redirect a power beam through free space. The mirror assembly is actuated on at least one axis, and preferably at least two axes, so that it can move through many angles based on control signals from the power beaming system. In a power beaming system, two or more of these mirrors can be used, thus creating many different beam paths through a volume of free space.

In one embodiment, the apparatus with a reflecting surface receives an optical transfer of power through free space from a power beam transmitter. Thus, the movement of the mirror is powered from the power beam itself.

The features and advantages described in this summary and the following detailed description are not all-inclusive. Many additional features and advantages will be apparent to one of ordinary skill in the art in view of the drawings, detailed description, and claims.

### BRIEF DESCRIPTION OF THE DRAWINGS

FIG. 1 illustrates a mirror assembly for power beaming, in accordance with one embodiment.

FIG. 2 illustrates a system including two mirrors for power beaming, in accordance with one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

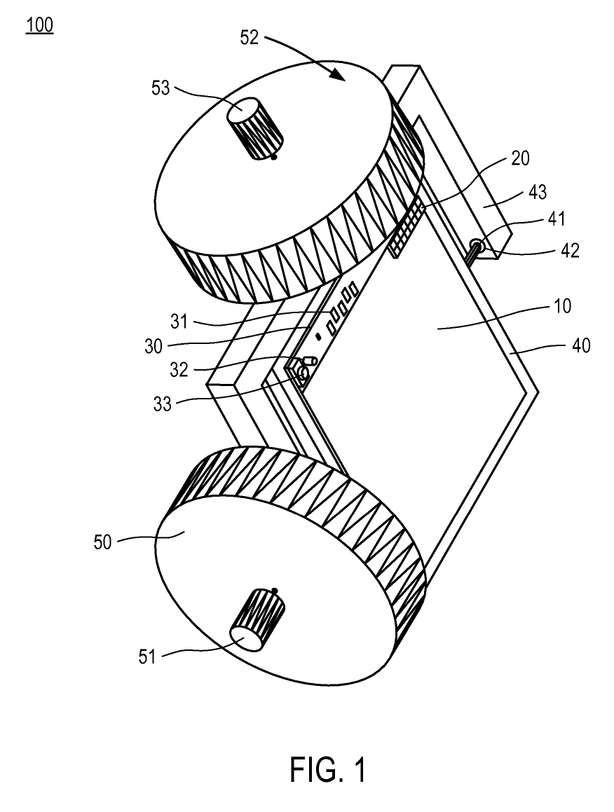

FIG. 1 illustrates a mirror assembly 100 for power beaming, in accordance with one embodiment. The mirror assembly 100 includes a reflective surface 10 supported by a case 40.

The reflective surface 10 can be a standard optical mirror, such as mirrors sold by Thorlabs, Inc., of Newton, N.J. The choice of the mirror material can depend on the wavelength of light in the power beam. Preferably, the mirror should be constructed from a material that reflects efficiently at the wavelength transmitted by the power beaming system. The size of the mirror can depend on the size of the power beam. For example, if the cross-section of the power beam is exactly round, one inch in diameter, and the mirror is to be used at up to 45 degrees to the power beam, in one embodiment, the mirror should be at least 1.414 inches in diameter to reflect the entire cross section of the power beam.

The case 40 mechanically supports the reflective surface 10. An injection molded case is a normal thermoplastic is inexpensive and robust. In one implementation, the case can also hold the electronic components described herein.

The case 40 is connected to shaft 42 which is connected through bushing 41 to the yoke 43. In one embodiment, the shaft 42 is molded with the case 40, but alternatively, shaft 42 can be molded separately. In one embodiment, a ¼ inch shaft is used. On the side of the mirror's shaft that swings freely, a bushing 41, such as an inexpensive copper bushing, is used. Alternatively, many other bushings 41 can be used. The yoke 43 can also be molded plastic. In FIG. 1, the yoke 43 is shown suspended from a transmission 52. An exterior case from which transmission 52 and motor 53 are suspended is not shown. Such an exterior case can be taped, screwed or otherwise affixed to a wall, ceiling, or other surface.

In the example shown, the mirror assembly 100 has two axes of rotation comprising a mechanism for adjusting the reflective surface 10 to redirect the reflection of incident light in at least one dimension. In one embodiment, the mechanism comprises a pan-and-tilt system operated by motors 51 and 53. In implementations where accuracy is important, motors 51 and 53 can be stepper motors or servo motors, for example. In one embodiment, a stepper motor is preferred because it is cheaper. Because the gear ratio is very high, the stepper motor can be very small.

In implementations wherein the mirror assembly 100 is light and need not move fast but accuracy is important, it is useful to include a transmission 50, 52 between the motors 51, 53 and the mirror yoke 43. A transmission 50, 52 converts the torque from the motor 51, 53 into motion for the mirror 10. A normal stepper motor may step at 15 degrees per step, but, in one embodiment, aiming a power beam over tens of meters with millimeter precision requires accuracy well under 1 degree. In one embodiment, a reduction of 8000:1 is used. This provides accuracy of less than 1 mm at 20 m. In one implementation, the transmission 50, 52 uses three large 48-pitch spur gears and three small ones. To produce the mirrors of the present invention in high volume, nylon gears can be used, for example gears similar to those sold commercially by Stock Drive Products. Alternatively, there are many suppliers of complete planetary gear assemblies. For example, Donovan Microtek sells 6 mm stepper motors and planetary transmissions with a reduction of 4096:1.

In one embodiment, to power all of the above, the mirror assembly 100 converts light from a power beam to electricity using power conversion devices 20. In one embodiment, the power conversion devices 20 are photodiodes that convert light to electricity. Edtek Incorporated of Kent, Wash., makes adequate GaSb photodiodes. Essential Research, Inc. of Cleveland, Ohio, makes InGaAs on InP photodiodes. JDS Uniphase Corporation of Milpitas, Calif., has the ability to make highly efficient InP photodiodes. Cheaper germanium diodes have been made by Spectrolab, Inc. of Sylmar, Calif. Because the size, shape, arrangement, and number of the diodes affect the current and voltage, for many applications, custom diodes are better than those available “off-the-shelf.” The surface area and number of photodiodes can be chosen so that an appropriate series-parallel arrangement will provide sufficient current at an appropriate voltage. It may be useful to put an optical element in-line with the photodiodes to focus-down energy on them. Another alternative for power conversion devices 20 is to use quantum dots or other nanotechnological power conversion devices.

In one embodiment, a series-parallel arrangement of the photodiodes is used as the power conversion devices 20. GaSb diodes, for example, operate at approximately 0.4V. If the electronics 31 require 3.3V and the motors 51, 53 require 5V, 14 diodes in series can be used for 5.6V. This allows for low dropout regulators. The current is proportional to the intensity of the power beam and relates to the exact design of the diode, specifically the materials chosen and the way the electrodes are designed and fabricated. For example, assume: 1) the continuous current requirement is 250 mA; 2) the photodiode efficiency is 0.8A/W; 3) there is no concentrating lens in front of the diodes; 4) the maximum angle to the beam is 45 degrees; 5) and the laser providing power has a cross-sectional power of 10 mW/sq. mm. In this case, 0.25A/0.8A/W=0.3125 W incident. It will require 31.25 sq·mm if the photodiode were perpendicular to the beam. The photodiode is unlikely to be perpendicular to the beam because, in one embodiment, the photodiode is coplanar with the reflective surface 10, which is being used to steer the beam. So, assuming the worst case angle between the beam and the photodiode of 45 degrees, the photodiode will actually have to be larger by approximately a factor of 2, or about 62.5 sq·mm. Prudence would suggest making it slightly larger to allow for misalignment and would require a diffuser before it and slightly more current to increase efficiency. If the diodes were made of GaSb, this arrangement would provide the 250 mA at 0.4V. If 25 mA at 4.0V is desired, one creates a diode with 10 segments in series.

The position of the power conversion devices 20 on a mirror assembly 100 should not block the portion of the power beam that is destined for other devices to be powered, including additional downstream mirrors 100. One approach is to have a main power beam with a secondary power beam parallel to it, wherein the secondary power beam is to power the mirror assembly 100. Another alternative is to select an area of the power beam that downstream devices to be powered will not use. On each of the mirrors 100 used in series within a system, the respective power conversion devices 20 must not overlap in the optical path, or the downstream mirror or mirrors 100 may not receive adequate power. If multiple mirrors 100 will be used with one transmitter in series, the respective power conversion devices 20 for each mirror can be placed in different locations with respect to the center of the mirror, assuming that the mirrors pivot around their centers, as shown.

The mirror assembly 100 also includes a printed circuit board 30 for electronics 31. The printed circuit board 30 can be any printed circuit board that is laid out for the electronic components it will hold. The electronic components 31 can include, for example, a microprocessor, a voltage regulator, stepper drivers, an oscillator, noise-decoupling capacitors, and sensors. In one embodiment, the electronic components include a Microchip PIC 8-bit microprocessor, or equivalent microprocessor. In one embodiment, the electronics include an ADC to read-out a photodiode 33 for communication, described below. In one embodiment, a mirror assembly 100 can be panned and tilted using analog means, but in some embodiments, it is easier and more flexible to use a microprocessor to control the motors 51, 53. The microprocessor can take instructions communicated from the power source as to what angle to assume, or the microprocessor can infer the best angle from sensors.

In one embodiment, the mirror assembly 100 also has a transmitter and/or receiver to communicate with an upstream source of a power beam, for example, to receive control signals indicating how to adjust the reflective surface 10. Any real-time communication system can be used. One option is an optical means of communication such as a photodiode to receive a signal and an infrared light source to transmit a signal. Alternatively, an RF communication method, such as a Zigbee IC and the associated circuitry, such as an RF transceiver, can be used in place of the light source and photodiode.

In one embodiment, mirror assembly 100 includes a light source 32 and a photodiode 33 used for communication with an upstream source of a power beam. In one embodiment, light source 32 and photodiode 33 are a cheap, convenient way to communicate to the power beaming source in real-time and at high-bandwidth. For example, a stock infrared photodiode 33 on the mirror assembly 100 can be used to receive a single from a matching LED on the upstream source of the power beam in some implementations, as is done with IRDA. Similarly, a photodiode on the source of the power beam can be used to receive a signal from a matching light source 32 on the mirror assembly 100. For some embodiments, stock infrared photodiodes 33 and LEDs are not sufficient, because most have fields of view of 30 degrees or less. In some embodiments, the photodiode 33 and light source 32 of the mirror assembly 100 should have fields of view greater than the greatest angle at which the power beam will strike the reflective surface 10 of mirror assembly 100. For example, if the power beam may strike the reflective surface 10 of mirror assembly 100 at up to 45 degrees and the photodiode 33 of the mirror has a 30 degree field of view, the photodiode 33 will not receive any signal from a device that transmits the power beam from the angles between 30 and 45 degrees. In these situations, one could use a light source 32 and a photodiode 33 in custom packages. If an optical means to communicate with an upstream source of a power beam is used, an amplifier can be used with the photodiode 33. It may also be useful in some implementations to use a VCSEL instead of an LED to increase brightness.

When an optical solution is used, the locations of the light source 32 and photodiode 33 on the printed circuit board 30 matters. Because two or more mirrors 100 may be used, it is best if the optical components 32, 33 are arranged so as to avoid overlap in the optical path, for example, by placing them in different areas of the printed circuit board 30 of each mirror assembly 100.

In addition to the above described components of the mirror assembly 100, optionally, sensors may be attached to or included in the mirror assembly 100. For example, it can be useful to mount a camera on the mirror apparatus to view the optical path, to locate devices to which to direct power, to determine path obstructions, or for other purposes.

Optionally, one can add a battery and charging circuit to the mirror assembly 100, for implementations where it is desirable to maintain power to the mirror assembly 100 when the power beam is off. Stepper motors, for example, require a holding current. Thus, a battery allows the mirror assembly 100 to maintain the position of the reflective surface 10, even if the power beam were temporarily blocked or turned off.

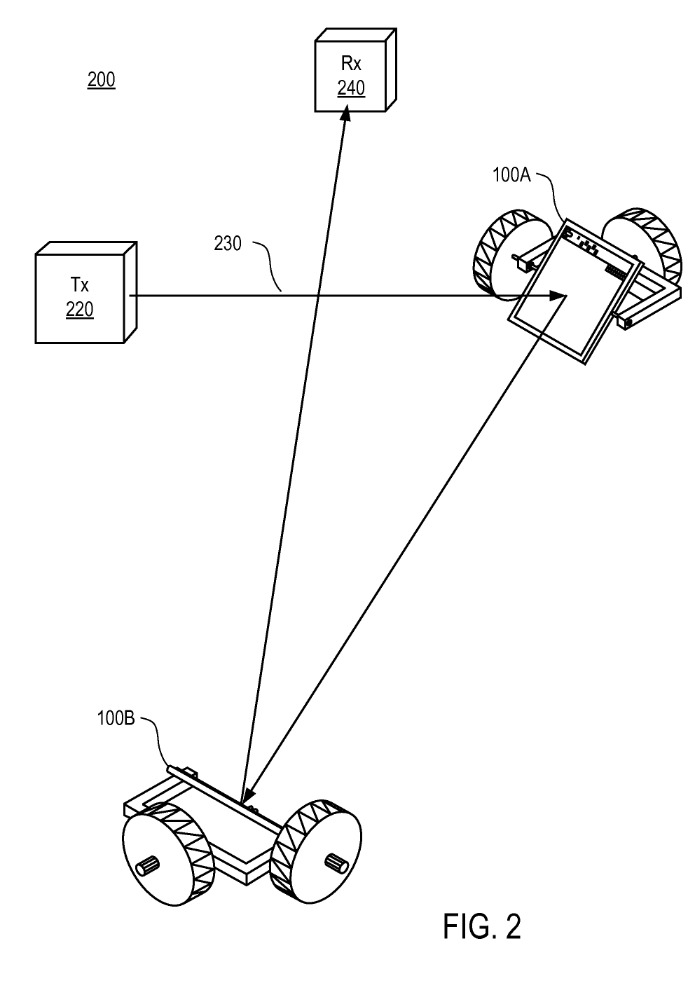

As shown in the example of FIG. 2, one embodiment of the wireless power beaming system 200 includes a transmitter 220, a free space optical path 230, two mirror assemblies 100A and 100B, and a receiver 240 having an optical-to-electric power converter. In one arrangement, mirrors 100A and 100B are mounted on walls of a room in which the receiver 240 is located. Transmitter assembly 220 is a source of an optical power beam. The optical power beam travels through free space 230 to a first active mirror assembly 100A, which directs the light to a second active mirror assembly 100B, which directs the light to a receiver 240. FIG. 2 depicts merely the center of the optical power beam traveling the free space optical path 230 throughout the system. In some embodiments, several parallel optical power beams travel similar paths from the transmitter 220. As described herein, a portion of one or more of the optical power beams from transmitter 220 are received by the power conversion devices 20 of each mirror assembly 100A, 100B.

As discussed above, the respective power conversion devices 20 of the mirrors 100A, 100B are arranged to use different portions of the power beam, so as to prevent the first mirror assembly 100A from preventing power from reaching the downstream mirror assembly 100B. Likewise, the respective optical components 32, 33 of each of the mirrors 100A, 100B are arranged so as to avoid overlap in the portions of the optical path used. Thus, for example, the paths of communication to and from the downstream mirror assembly 100B are not interrupted.

In various embodiments, the combination of mirrors 100A and 100B can be used to avoid objects in between the power transmitter 220 and the power receiver 240. The mirrors 100A and 100B create multiple possible paths for the power beam within a volume, such that a receiver 240 can be illuminated from many different angles, or to allow the power beaming device to easily scan a room and to deliver power to a device that is not fixed, and for which there is no predefined beam path. Thus, cell phones, laptop computers, vacuum cleaners, and other devices that move from time to time can be conveniently powered using a power beam. In addition to being able to beam power to target devices from different angles by using the mirror assemblies described herein, if the power transmitter 220 includes a camera, the camera can be used to search for and see the target devices from different angles as well.

Another advantage of embodiments of system 200 that include at least one mirror assembly 100 is that it allows for many beam paths, and therefore many angles of approach to a device having a receiver 240. For example, a laptop computer may be on a table, with a person working at it. It is necessary to choose a beam path that avoids the person, but this alone is insufficient. If the receiving surface is on the exterior of the laptop behind the display, it is necessary to choose an angle that can hit the receiving surface and that can strike it at a sufficiently acute angle for the safety and efficiency of the system 200. Generally, angles steeper than about 45 degrees are acceptable. Beyond this, the receiving surface presents a small surface to the beam.

For implementations of the system 200 that beam power to fixed objects or to objects that moved from time to time, the mirror of the present invention is more convenient than a fixed mirror. When a fixed mirror is installed, it must be aimed. When an installer uses the actuated mirror assembly 100, there is no aiming required during installation. Also, if the installation is subject to vibration or creep, e.g., as a house settles or expands and contracts through the seasons, the mirror assembly 100 of the present invention can compensate for this without human intervention.

In addition, the actuated mirror assembly 100 is not required to be plugged in, because it can be configured to be powered from the power beam transmitted by the transmitter 220. Thus, the placement of the mirrors 100A and 100B can be chosen without regard to the availability of power outlets, or other sources of power, which is a key benefit to a power beaming system.

Although the description above contains many specifics, these should not be construed as limiting the scope of the invention but as merely providing illustrations of some presently preferred embodiments of this invention. For example, optional electronics, including batteries, sensors, cameras, etc. are not shown in FIG. 1, but would be understood to be optional by those of skill in the art. The positions of some of the elements may be shifted.

The present invention has been described in particular detail with respect to several possible embodiments. Those of skill in the art will appreciate that the invention may be practiced in other embodiments. First, the particular naming of the components and capitalization of terms is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage devices. Certain aspects of the present invention include process steps and instructions. It should be noted that the process steps and instructions of the present invention could be embodied in software, firmware or hardware, and when embodied in software, could be downloaded to reside on and be operated from different platforms. Furthermore, the computers referred to in the specification may include a single processor or may be architectures employing multiple processor designs for increased computing capability.

The scope of this invention should be determined by the appended claims and their legal equivalents, rather than by the examples given.

What is claimed is:

1. An actuated mirror assembly for redirecting an optical power beam through free space, the mirror assembly comprising:
a reflective surface for reflecting a first portion of an optical power beam;
a mechanism for adjusting the reflective surface to redirect the reflected first portion of the optical power beam in at least one dimension; and
a power conversion device for receiving a second portion of the optical power beam to power the mechanism for adjusting the reflective surface.

2. The mirror assembly of claim 1, wherein the reflective surface is larger than the cross section of the optical power beam.

3. The mirror assembly of claim 1, wherein the mechanism for adjusting the reflective surface comprises a pan and tilt system to redirect the reflected first portion of the optical power beam in at least two dimensions.

4. The mirror assembly of claim 3, wherein the pan and tilt system comprises a stepper motor.

5. The mirror assembly of claim 4, wherein the pan and tilt system further comprises a transmission coupled between the stepper motor and a yoke on the reflective surface.

6. The mirror assembly of claim 1, wherein the power conversion device is a photodiode.

7. The mirror assembly of claim 1, further comprising a transmitter for communicating with a source of the optical power beam.

8. The mirror assembly of claim 7, wherein the transmitter comprises an RF transmitter.

9. The mirror assembly of claim 7, wherein the transmitter comprises a light source.

10. The mirror assembly of claim 1, further comprising a receiver for communicating with a source of the optical power beam.

11. The mirror assembly of claim 10, wherein the mechanism adjusts the reflective surface responsive to control signals received from the source of the optical power beam.

12. The mirror assembly of claim 10, wherein the receiver comprises an RF receiver.

13. The mirror assembly of claim 10, wherein the receiver comprises a photodiode.

14. The mirror assembly of claim 13, wherein the photodiode has a field of view encompassing all angles at which the optical power beam strikes the reflective surface.

15. The mirror assembly of claim 1, further comprising a camera to view a path of the optical power beam.

16. The mirror assembly of claim 1, further comprising a battery coupled to the power conversion device.

17. An actuated mirror assembly for redirecting an optical power beam through free space, the mirror assembly comprising:
a reflective surface for reflecting a first optical power beam;
a mechanism for adjusting the reflective surface to redirect the reflected first optical power beam in at least one dimension; and
a power conversion device for receiving a second optical power beam to power the mechanism for adjusting the reflective surface.

18. The mirror assembly of claim 17, wherein the second optical power beam is substantially parallel to the first optical power beam.

19. A system for power beaming through free space, the system comprising:
a source of an optical power beam;
a first mirror assembly comprising
a first reflective surface for reflecting a first portion of an optical power beam,
a first mechanism for adjusting the first reflective surface to redirect the reflected first portion of the optical power beam in at least one dimension, and
a first power conversion device for receiving a second portion of the optical power beam to power the first mechanism for adjusting the reflective surface; and
a receiver for receiving at least a portion of the reflected first portion of the optical power beam.

20. The system for power beaming of claim 19, the system further comprising:
a second mirror assembly comprising
a second reflective surface for reflecting a third portion of the optical power beam received via reflection from the first mirror assembly,
a second mechanism for adjusting the second reflective surface to redirect the reflected third portion of the optical power beam in at least one dimension to the receiver, and
a second power conversion device for receiving a fourth portion of the optical power beam received via reflection from the first mirror assembly to power the second mechanism for adjusting the second reflective surface.

21. The system for power beaming of claim 20, wherein the first and second power conversion devices receive non-overlapping portions of the optical power beam.

22. The system for power beaming of claim 20, wherein the first mirror assembly and the second mirror assembly each further comprises a respective receiver for receiving communications from the source of the optical power beam.

23. The system for power beaming of claim 22, wherein each respective receiver for receiving communications from the source of the optical power beam comprises a photodiode.

24. The system for power beaming of claim 21, wherein first mechanism adjusts the first reflective surface responsive to control signals received from the source of an optical power beam.

25. The system of claim 20, wherein the source of an optical power beam comprises a camera.
